(19) United States
(12) Patent Application Publication
(10) Pub. No.: US 2023/0329402 A1
(43) Pub. Date: Oct. 19, 2023

(54) Method for producing a rigid shell for luggage, shell for luggage and luggage

(71) Applicant: LOUIS VUITTON MALLETIER, Paris (FR)

(72) Inventors: Olivier LEGUILLOU, Saint Clair du Rhone (FR); Kathleen SCULLY, Paris (FR)

(73) Assignee: LOUIS VUITTON MALLETIER, Paris (FR)

(21) Appl. No.: 17/267,807

(22) PCT Filed: Aug. 8, 2019
(86) PCT No.: PCT/FR2019/071377

§ 371 Date: Feb. 10, 2021

(30) Foreign Application Priority Data
Aug. 10, 2018 (FR) 1857463

(51) Int. Cl. A45C 5/02; B29C 70/48; B29C 70/22; B29C 70/88

(52) U.S. Cl. CPC A45C 5/02; B29C 70/222; B29C 70/48; B29C 70/88; B29L 2031/7418

(57) ABSTRACT

A method for producing a shell for luggage, comprising: a) producing a preform comprising a structure and including a reinforcement, the structure, which comprises a main zone, two longitudinal zones and two transverse zones, having loops successively forming rows of loops, the rows of loops being connected to each other, and b) placing the preform on a punch, c) impregnating the reinforcement of the preform with a matrix material in order to produce a shell comprising a body, the body being made of a composite material and comprising the matrix and the reinforcement, and the body having a main wall, two longitudinal walls and two transverse walls.

### FIELD OF THE INVENTION

The present invention relates to a rigid shell for luggage, the luggage comprising the shell, and a method for producing the shell.

### CONTEXT OF THE INVENTION

Various luggage items exist that comprise two shells connected by a hinge, each shell having a main wall, two longitudinal walls, and two transverse walls. The invention relates more particularly to the production of a shell comprising a rigid (and preferably waterproof) body of composite material comprising a matrix and a reinforcement.

Such luggage is known in particular from document WO2017/140982A1. However, although such a luggage is satisfactory, the present invention aims to simplify its production, reduce the manufacturing cost, and increase its robustness and/or reduce its weight.

### DISCLOSURE OF THE INVENTION

To do this, a first aspect of the invention proposes a method comprising:
a) producing a preform comprising a structure, the preform including a reinforcement, the structure comprising a main zone, two longitudinal zones, and two transverse zones, the structure having loops successively forming rows of loops, the rows of loops being connected to each other,
b) placing the preform on a punch, and
c) impregnating the reinforcement of the preform with a matrix material in order to produce a shell comprising a body, the body being made of composite material and comprising the matrix and the reinforcement, and the body having a main wall, two longitudinal walls, and two transverse walls.

The presence of loops in the structure of the preform allows great flexibility for deforming the structure, even for a preform extending over several tens of centimeters in two dimensions. Thus, during step a) the structure is produced as flat, or at least is suitable for being arranged flat with a height of a few millimeters (preferably less than one centimeter), and can be shaped to have a three-dimensional shape with a depth of several centimeters to several tens of centimeters. The desired three-dimensional shape is in particular such that the preform has a hollow shape defining an interior volume. The transverse zones and the longitudinal zones extend generally perpendicularly to the main zone and continuously from the main zone. The transverse zones extend perpendicularly to the longitudinal zones with continuity of the structure between the main zone, the transverse zones, and the longitudinal zones. In other words, the desired three-dimensional shape is schematically obtained in particular, starting from the flat structure, by folding each of the two transverse zones and two longitudinal zones, the folding of each transverse portion intersecting the folding of each of the longitudinal zones, and the folding of each longitudinal portion intersecting the folding of each of the transverse zones. The achievable shapes and more generally the range of aesthetic possibilities are increased.

Conversely, a woven structure allows only disjoint folds to be created (not intersecting), which only allows a developable shaping sometimes referred to as 2.5 D (unless a discontinuity of the material is created in particular between the transverse zones and the longitudinal zones), unlike the invention which allows 3D shaping with complete continuity between the main zone and the transverse zones and the longitudinal zones, and between the transverse zones and longitudinal zones which form a continuous edge.

According to another feature of the invention, in step a), the structure of the preform is preferably produced by knitting.

The technique of knitting can usually be defined as consisting of forming loops, called stitches, which pass through one another. This makes it possible to produce a satisfactory structure of various dimensions, quickly and easily.

According to an additional feature of the invention, the structure of the preform is preferably produced by forming:
a first row of loops with a main thread,
a second row of loops while passing the main thread through the loops of the first row of loops,
and so on in a series of rows of loops, passing the same main thread of a row of loops through the loops of the previous row of loops.

According to yet another additional feature of the invention, preferably in the main zone:
the rows of loops extend in a longitudinal direction, and
the rows of loops follow one after another in a transverse direction perpendicular to the longitudinal direction.

According to yet another additional feature of the invention, preferably in the longitudinal zones, the rows of loops extend in the longitudinal direction.

The production of the entire structure is thus relatively easy and the robustness of the produced shell is improved.

According to an additional or alternative feature of the invention, preferably in at least the major portion of the transverse zones, the rows of loops follow one after another in the transverse direction.

The production of the entire structure is thus relatively easy and the robustness of the produced shell is further improved.

According to another additional or alternative feature of the invention, the structure preferably comprises at least two connection zones each arranged between one of the longitudinal zones and one of the transverse zones.

According to another additional or alternative feature of the invention, preferably, during step a), the shape of the loops is varied in order to form at least one predetermined density zone and one high density zone.

The resistance of the obtained shell is thus adapted according to the zones undergoing the most mechanical stresses or the most friction.

According to another feature of the invention, preferably, during step a), the structure of the preform is produced such that:
in the predetermined density zone, the loops successively follow one after another with a first loop pitch and the rows of loops follow one after another with a first row pitch,
in the high density zone, the loops successively follow one after another with a first loop pitch and the rows of loops follow one after another with a first row pitch, and
the first loop pitch is greater than the second loop pitch by at least 50%, preferably double the second loop pitch.

Such a variation in the row pitch can easily be obtained with known knitting techniques while maintaining good structural strength between the predetermined density zone and the high density zone, so that a weakness of the shell at the junction between the zone of predetermined density and the high density zone is avoided.

According to an additional feature of the invention, the difference between the first loop pitch and the second loop pitch is preferably less than 20% of the first loop pitch, preferably less than 10% of the first loop pitch.

Varying the loop pitch while maintaining satisfactory coupling within the structure is difficult to achieve, so the loop pitch is preferably substantially constant throughout the structure.

According to another feature of the invention, the main thread preferably extends continuously over the entire structure of the preform.

The robustness of the shell produced by the method is thus further increased.

According to an additional feature of the invention, during step a), a secondary thread is preferably trapped in the loops of the structure.

Thus, because the preform further comprises a secondary thread, the strength of the obtained shell is improved by distributing the reinforcement within the structure and/or the obtaining of the shell is simplified by distributing the matrix material within the preform, depending on whether the secondary thread comprises a structural fiber and/or comprises the matrix material.

According to an additional feature of the invention, during step a), preferably the loops of each of the rows of loops alternately pass on one side then the other of the secondary thread.

The secondary thread is thus tightly bound to the structure and extends continuously within the structure. Preferably, the secondary thread, which may be formed of a plurality of filaments, extends continuously (the secondary thread is not formed of a plurality of disjoint portions) over the entire preform.

According to an additional or alternative feature of the invention, the secondary thread preferably comprises at least part of the reinforcement and/or of the matrix material.

The production of the shell is thus simplified, and the shell is reinforced or of better quality because the matrix material and the reinforcement can be uniformly distributed and be close to each other in the preform.

According to an additional feature of the invention, the secondary thread comprises a core forming at least part of the reinforcement, and the core is covered with a coating of thermoplastic polymer, the core and the coating of thermoplastic polymer preferably being coextruded.

The secondary thread thus contributes to the perform, both as a reinforcement and as a matrix, for the production of the composite shell.

According to an additional feature of the invention, the thermoplastic polymer is preferably polypropylene (PP) or polyethylene terephthalate (PET).

According to an additional or alternative feature of the invention, the core and the coating of thermoplastic polymer are preferably made of the same material.

Cohesion is thus improved.

According to another feature of the invention, the main thread is preferably produced from portions which alternate in coming from a first thread element and from a second thread element, the first thread element and the second thread element having different colors.

A shell is thus produced that is embellished with a decoration comprising at least two colors, without impacting the robustness of the shell or significantly complicating the production of the shell.

According to an additional feature of the invention, the first thread element and the second element preferably repetitively follow one after another in succession to produce a repeating pattern in the structure.

According to another feature of the invention, the reinforcement is preferably at least partly formed by the main thread.

According to another feature of the invention, the matrix material for impregnating the reinforcement during step c) is at least partly provided by the preform.

Production of the shell is thus simplified and the shell is of better quality because the matrix material and the reinforcement can be uniformly distributed and be close to each other in the preform.

According to yet another feature of the invention and which may be independent, preferably during step c) a matrix material of polyolefin is used, and during a step d) a covering of polyolefin is applied to the body.

Because the matrix material and the material of the covering are both of polyolefin, the adhesion between the body and the covering is improved, avoiding the interposition of an adhesive.

When this feature is independent, the invention relates to another aspect in which the method for producing a shell for luggage comprises:
producing a body, the body having a main wall, two longitudinal walls, and two transverse walls, the body comprising a polyolefin material, then
applying a polyolefin covering to the body.

According to an additional feature, preferably during step d) the covering and/or the body is heated and the covering is pressed against the body.

According to another additional feature of the invention, preferably during step d):
at least one among the covering and/or the body is heated to between 140 and 200 degrees, and
the covering is pressed against the body at a pressure of between 10 bar and 20 bar for a period of between 1 minute and 30 minutes.

According to an additional or alternative feature of the invention, the covering preferably comprises a foam layer and a film (non-lacunar with open cells, in particular not foamed), and during step d) the foam layer is applied against the body.

According to an additional feature of the invention, the foam layer preferably has a density of between 250 g/m² and 750 g/m², preferably between 450 g/m² and 500 g/m².

According to an additional or alternative feature of the invention, preferably during a step d′) prior to step d):
the covering is cut in the shape of a cross having a central zone and four peripheral zones (the central zone is preferably rectangular), the peripheral zones each having two side edges extending from the central zone, and
the peripheral zones are folded (in particular bent) perpendicularly to the central zone and each side edge is brought into contact with a side edge which is adjacent.

According to an additional feature of the invention, the peripheral zones are preferably trapezoidal.

The side edges thus do not extend into the corners of the shell, which improves the strength of the shell.

According to an additional or alternative feature of the invention, during step d′) said side edges which are adjacent are preferably heated and pressed together in order to weld them to one another.

According to an additional feature of the invention, during step d′), a roller is preferably rolled over said edges which are adjacent.

According to another additional or alternative feature of the invention, during step d), the covering applied to the body is preferably of a material that for the most part (more than 50%), more preferably essentially (at least 90%), is the same as that of the matrix material, preferably polypropylene.

The invention further relates to a shell for luggage comprising a body, said body being rigid (and preferably waterproof), of composite material and comprising a matrix and a reinforcement, the body having a main wall, two longitudinal walls, and two transverse walls. In accordance with the invention, the reinforcement comprises at least one main zone comprising loops successively forming rows of loops, the rows of loops being connected to each other, and the reinforcement is embedded in the matrix.

According to an additional feature of the invention, preferably the reinforcement and the matrix each extend within the main wall, the two longitudinal walls, and the two transverse walls.

According to another additional feature of the invention, preferably, in the main wall, the rows of loops each extend in a longitudinal direction, and the rows of loops follow one after another in succession in an adjacent manner in a transverse direction perpendicular to the longitudinal direction.

According to another feature of the invention, the reinforcement comprises a main thread and said main thread is knitted. Preferably, said main thread forms said loops, the loops of a row of loops passing through the loops of the rows which are adjacent.

According to an additional feature, the main thread preferably extends within the main wall, the two longitudinal walls, and the two transverse walls, and more preferably throughout the body (the entire surface of the body).

According to another feature of the invention, the matrix is preferably made of thermoplastic polymer material, more preferably of polypropylene (PP) or polyethylene terephthalate (PET).

According to another feature of the invention, which may be independent, the matrix is preferably made of polyolefin and the composite body is covered with a covering made of polyolefin, preferably of polypropylene.

When this feature is independent, the invention relates to another aspect in which the shell for luggage comprises a body, said body is rigid (and preferably waterproof), the body has a main wall, two longitudinal walls, and two transverse walls, the body comprises a material made of polyolefin (preferably polypropylene) and is covered with a covering made of polyolefin (preferably polypropylene).

According to an additional feature of the invention, the covering preferably comprises a foam layer and a film (non-lacunar with open cells, in particular not foamed), the foam layer being interposed between the body and the film.

In various embodiments of the shell according to the invention, use may be made of one or more of the following arrangements:
the reinforcement is made of polypropylene (PP) or polyethylene terephthalate (PET),
the reinforcement is made of aramid, carbon, glass fibers, or linen,
the body has a predetermined density zone as reinforcement and a high density zone as reinforcement, the proportion of reinforcing material being at least 50% higher in the high density zone than in the predetermined density zone, and the shell comprises at least one wheel attached to the body in the high density zone.
the covering has a visible outer surface and said outer surface has a repeating pattern extending over the two longitudinal walls and the two transverse walls.

Lastly, the invention relates to a luggage comprising a first shell and a second shell, the second shell having one or more of the above features and the second shell being movable relative to the first shell between an open position and a closed position, the luggage having a closed interior volume in the closed position and having an access opening in the open position.

The first shell may have a relatively shallow depth, possibly even corresponding to the thickness particularly if the first shell is in the form of a plate (which may in particular curve inward) and/or if the first shell acts as an access door to the interior volume.

### BRIEF DESCRIPTION OF THE FIGURES

Other features and advantages of the invention will become apparent from the following detailed description, with reference to the accompanying drawings in which:

FIG. 1 is a perspective view of a piece of luggage according to the invention, in the closed position,

FIG. 2 is a perspective view of the piece of luggage in the open position,

FIG. 3 is an exploded perspective view of the piece of luggage,

FIG. 4 illustrates a first step in the production of a shell for luggage,

FIG. 5 is an enlarged schematic representation of the zone labeled V in FIG. 4,

FIG. 6 is an enlarged schematic representation of the zone labeled VI in FIG. 4

FIG. 7 schematically illustrates a main thread and a secondary thread according to one embodiment of the invention,

FIG. 8 illustrates a second step in producing the shell,

FIG. 9 illustrates a third step in producing the shell,

FIG. 10 illustrates the shell after the third step,

FIG. 11 illustrates a fourth step in producing the shell,

FIG. 12 illustrates a fifth step in producing the shell,

FIG. 13 illustrates the shell after the fifth step.

### DETAILED DESCRIPTION OF THE INVENTION

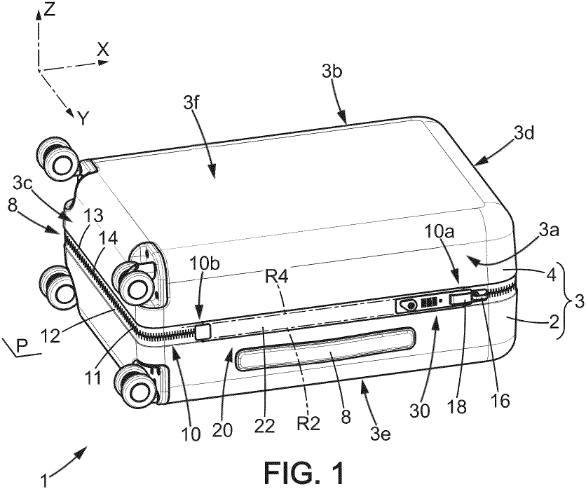

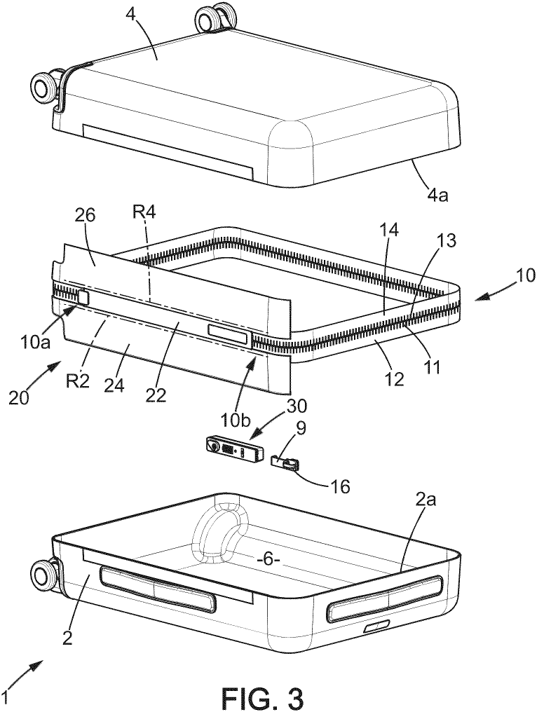

FIGS. 1 to 3 illustrate a piece of luggage essentially comprising a container 3 and a hinge device 20, as well as a zipper 10 and a locking device 9 (in FIG. 3).

In the illustrated embodiment, the piece of luggage defines a suitcase 1. The container 3 comprises a first shell 2 and a second shell 4 which are connected by a hinge device 20. The first shell 2 and the second shell 4 are relatively rigid. In addition, as illustrated in FIG. 1, the container 3 is substantially parallelepipedal. The container 3 comprises two large side faces 3a, 3b extending in a longitudinal direction X, two small side faces 3c, 3d (of smaller dimensions) extending in a transverse direction Y, a lower main face 3e, and an upper main face 3f. The lower main face 3e and the upper main face 3f are substantially planar and perpendicular to an upright direction Z, the upright direction Z being perpendicular to the longitudinal direction X and to the transverse direction Y. The two large side faces 3a, 3b and the two small side faces 3c, 3d extend along the upright direction Z. The two large side faces 3a, 3b are more specifically perpendicular to the transverse direction Y and the two small side faces 3c, 3d are more specifically perpendicular to the longitudinal direction X.

In the illustrated embodiment, the large side faces 3a, 3b and the small side faces 3c, 3d are connected to each other by means of rounded corner portions 7a, 7b, 7c, 7d. Although it is not preferred, the rounding of the corner portions 7a, 7b, 7c, 7d could be reduced until the corner portions 7a, 7b, 7c, 7d disappear, the large side faces 3a, 3b and the small side faces 3c, 3d then being connected to each other by sharp angles.

Additionally and optionally, the suitcase 1 comprises wheels arranged at the four corners of small side face 3c and a telescoping handle capable of projecting from side face 3d. The suitcase 1 further comprises a main carrying handle 8 arranged on the large side face 3a. In FIG. 1, the suitcase 1 is illustrated in a position in which it is intended to sit on the ground in order to open it, resting on its lower face 3e.

The container 3 defines an interior volume 6 (visible in particular in FIG. 3) intended to receive items so that they can be transported, in particular clothes.

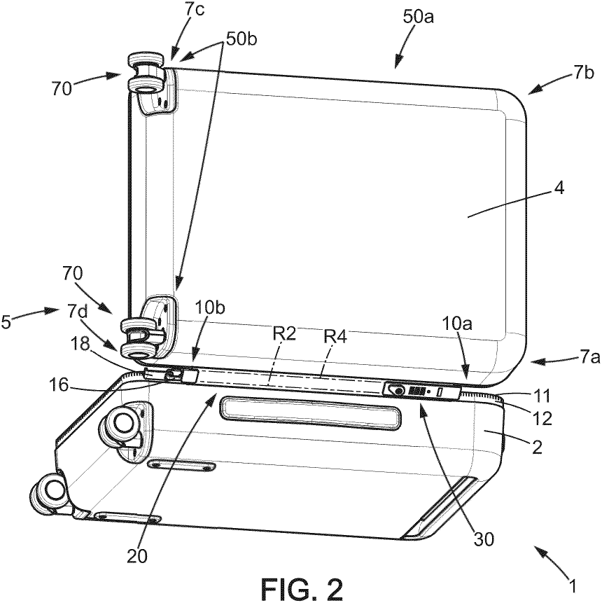

The first shell 2 and the second shell 4 are connected by a hinge device 20 which allows moving the first shell 2 and the second shell 4 relative to each other between a closed position illustrated in FIG. 1 and an open position illustrated in FIG. 2. In the closed position illustrated in FIG. 1, the second shell 4 is facing the first shell 2. The second shell 4 has an edge 4a generally coming into contact with an edge 2a of the first shell 2 along a joining plane P. In the open position, there is an access opening 5 (visible in particular in FIG. 2) between the first shell 2 and the second 4 in order to access the interior volume 6 to place items therein.

The hinge device 20 (visible in particular in FIGS. 1 to 3) is arranged at the level of the large side face 3a and essentially comprises a first support 24 fixed to the first shell 2, a second support 26 fixed to the second shell 4, and an intermediate element 22 extending between the first support 24 and the second support 26. The intermediate element 22 is hinged to rotate relative to the first support 24, and consequently to the first shell 2, about a first hinge axis R2. The intermediate element 22 is hinged to rotate relative to the second support 26, and consequently to the second shell 4, about a second hinge axis R4. The first hinge axis R2 and the second hinge axis R4 both extend parallel to the joining plane P and substantially at the level of the large side face 3a in the closed position of the suitcase 1. The first hinge axis R2 and the second hinge axis R4 are therefore parallel to each other and spaced apart from one another

In the closed position, the zipper 10 extends between a first longitudinal end 10a and a second longitudinal end 10b. The first longitudinal end 10a and the second longitudinal end 10b are both located at the level of the large side face 3a. Between the first longitudinal end 10a and the second longitudinal end 10b, the zipper extends along the joining plane across the side faces 3d, 3b, 3c.

The zipper 10 comprises a first strip 12 having a first longitudinal edge 11, a second strip 14 having a second longitudinal edge 13, a slider 16, and a puller 18. The slider 16 is adapted to move between a closing position in which it is close to the first longitudinal end 10a and an open position in which it is close to the second longitudinal end 10b.

When the slider 16 is in the closing position, the first longitudinal edge 11 is held adjacent to the second longitudinal edge 13. For this purpose, the first longitudinal edge 11 and the second longitudinal edge 13 are provided with complementary teeth arranged so that they alternate along the first longitudinal edge 11 and second longitudinal edge 13, as is well known. Alternatively, other types of zipper could be used.

When the slider 16 is in the open position, the first longitudinal edge 11 is released relative to the second longitudinal edge 13, between the first longitudinal end 10a and the second longitudinal end 10b.

When the slider 16 is in the closing position, the suitcase 1 is held in the closed position, the second shell 4 being in contact with the first shell 2, so that the interior volume 6 is closed, preventing access. When the slider 16 is in the open position, the second shell 4 can be moved between the open position and the closed position due to the hinge device 20, as described above.

The locking device 9 is able to cooperate with the slider 16 to keep it in the closed position.

The production of the suitcase 1 and more particularly of the second shell 4 will now be described.

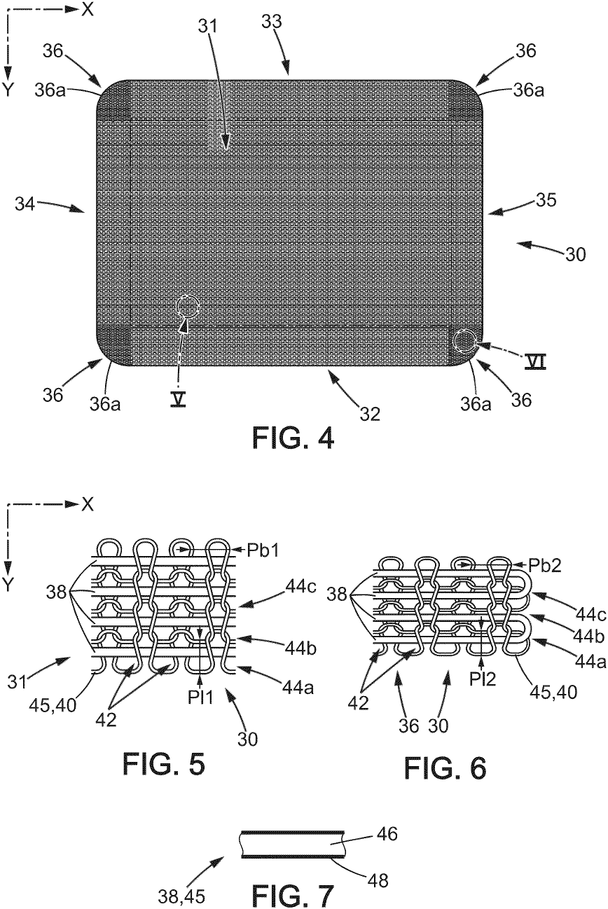

As illustrated in FIG. 4, a preform 30 comprising a structure 40 and a secondary thread 38 is first produced. The structure 40 comprises a main zone 31, a first longitudinal zone 32, a second longitudinal zone 33, a first transverse zone 34, a second transverse zone 35, and four connection zones 36.

The main zone 31 is located in the center of the structure 40 and is rectangular. The main zone 31 constitutes the major zone of the structure 40. The main zone 31 is intended to create the upper main face 3f of the second shell 4.

The first longitudinal zone 32, the second longitudinal zone 33, the first transverse zone 34, the second transverse zone 35, and the connection zones 36 are arranged around the main zone 31.

It should be noted that the separation of the structure into the main zone 31, first longitudinal zone 32, second longitudinal zone 33, first transverse zone 34, second transverse zone 35, and connection zones 36 is intended to allow establishing a correspondence with the different walls of the shell to be produced, but is not necessarily visible. In particular, in the illustrated embodiment, the border between the main zone 31, the first longitudinal zone 32, the second longitudinal zone 33, the first transverse zone 34, and the second transverse zone 35, represented by a line of short and long dashes, is fictitious.

The structure 40 is flexible and can be placed in a substantially planar position illustrated in FIG. 4.

In the illustrated embodiment, the first longitudinal zone 32, the second longitudinal zone 33, the first transverse zone 34, and the second transverse zone 35 are rectangular. They are respectively intended to produce the large side faces 3a, 3b and the small side faces 3c, 3d of the second shell 4.

The connection zones 36 are substantially square, with an outer edge 36a which may be rounded. The connection zones 36 are intended to create rounded corner portions 7a, 7b, 7c, 7d arranged at the four corners of the shell 4 (as illustrated in FIG. 2).

Alternatively, if the second shell 4 has sharp corners instead of the rounded corner portions 7a, 7b, 7c, 7d, the preform 30, and in particular the structure 40, would retain the same shape but the connection zones 36 would no longer exist as such, the parts corresponding to the connection zones then being distributed between the first longitudinal zone 32, the second longitudinal zone 33, the first transverse zone 34, and the second transverse zone 35, which would then each have a trapezoidal shape.

In the illustrated embodiment, the structure 40 is produced by knitting a main thread 45. As illustrated in particular in FIGS. 5 and 6, the structure 40 is formed by loops 42 successively forming rows of loops 44a, 44b, 44c extending in the longitudinal direction X. Alternatively, the rows of loops 44a, 44b, 44c could extend in the transverse direction Y.

A first row of loops 44a is formed, then a second row of loops 44b is formed while passing the main thread 45 through the loops 42 of the first row of loops 44a. As shown in FIG. 6, the first row 44a is formed in one direction (from left to right in the figure), then at the end of the first row 44a, the main thread 45 is bent 180 degrees and the second row of loops 44b is formed in the opposite direction (from right to left in FIG. 6).

In the illustrated embodiment, at the same time as a row of loops 44a, 44b, 44c is being formed, the secondary thread 38 is integrated into the preform 30. The secondary thread 38 is inserted into the structure 40 as the structure 40 is produced, by arranging the secondary thread 38 along the same direction and with the same directional orientation as the rows of loops 44a, 44b, 44c, in other words along the longitudinal direction X in the illustrated embodiment (from left to right for the first row of loops 44a and from right to left for the second row of loops 44b), and alternately forming loops 42 above and below the secondary thread 38. Similarly to the main thread 45, the secondary thread 38 is bent 180 degrees at the end of the first row of loops 44a and heads in the opposite direction in the second row of loops 44b.

When they reach the end of the second row of loops 44b which substantially corresponds to the beginning of the first row of loops 44a, the main thread 45 and the secondary thread 38 are again bent 180 degrees and a third row of loops 44c is formed, from left to right like the first row of loops 44a, the main thread 45 passing through the loops 42 of the second row of loops 44b and the secondary thread 38 being placed alternately above and below the loops 42, and so on until all the rows of loops 44a, 44b, 44c of the structure 40 are formed, the rows of loops 44a, 44b, 44c following one after another in the transverse direction Y.

The secondary thread 38 is thus distributed substantially uniformly throughout the structure 40 while remaining restricted to within the extent of the structure 40.

The main thread 45 and the secondary thread 38 are preferably continuous through the entire preform 30. However, the main thread 45 and the secondary thread 38 may each be composed of a plurality of contiguous filaments extending over the entire preform 40. Conversely, the main thread 45 and the secondary thread 38 may each be composed of a succession of segments of thread elements of different colors in order to create a pattern on the upper shell 4, the segments of thread elements being joined together, fixed end to end, or the like.

In the illustrated embodiment, the rows of loops 44a, 44b, 44c extend in the same direction both in the main zone 31 and in the first longitudinal zone 32, second longitudinal zone 33, first transverse zone 34, second transverse zone 35, and connection zones 36. Alternatively, the rows of loops 44a, 44b, 44c of one of the zones 31, 32, 33, 34, 35 of the structure 40 could extend perpendicularly (along the transverse direction) to the rows of loops 44a, 44b, 44c of another zone of the structure.

As illustrated in FIG. 5, in the main zone 31, the loops 42 successively follow one after another in the longitudinal direction X with a first loop pitch Pb1 and the rows of loops 44a, 44b, 44c follow one after another in the transverse direction Y with a first row pitch PI1.

As illustrated in FIG. 6, in the connection zones 36, the loops 42 successively follow one after another in the longitudinal direction X with a second loop pitch Pb2, and the rows of loops 44a, 44b, 44c follow one after another in the transverse direction Y with a second row pitch PI2.

In the illustrated embodiment, the first row pitch PI1 is double the second row pitch PI2, while the first loop pitch Pb1 is substantially equal to the second row pitch PI2. The variation of the row pitch can be obtained by varying the tension on the main thread 45, by knitting every other stitch, by changing the knitting point, or any other conventional method known in the field.

The variation of the row pitch P11, PI2, as well as the variation of the loop pitch Pb1, Pb2, make it possible to vary the density of the main thread 45 in the preform.

In the illustrated embodiment, the density of the main thread 45 has been increased in the connection zones 36 in order to increase the mechanical strength and wear resistance of the corner portions 7a, 7b, 7c, 7d of the second shell 4, in particular for the corner portions 7c, 7d to which the wheels 70 are attached.

In the illustrated embodiment, the density of the main thread 45 is the same in the first longitudinal zone 32, second longitudinal zone 33, first transverse zone 34, second transverse zone 35, as in the main zone 31. However, provision could be made to increase the density of the main thread 45 in one or the other of these zones of the structure 40.

As illustrated in FIG. 7, in the illustrated embodiment, the main thread 45 and the secondary thread 38 are of the self-reinforced polymer type, usually called SRP, and each comprise a core forming a reinforcement 46 and a coating forming the matrix material 48. The core is made of the same material as the coating, but the material of the core is compacted and/or its orientation is changed relative to the coating, in order to improve its mechanical properties and increase the temperature at which it melts. The main thread 45 and the secondary thread 38 are preferably made of polypropylene, usually called SRPP (Self Reinforced Polypropylene).

The structure 40 and the secondary thread 38 thus each provide the reinforcement 46 (due to the core) and the matrix 48 (due to the coating) for producing a composite material, preferably of thermoplastic polymer.

Alternatively, one among the main thread 45 and the secondary thread 38 could provide only the reinforcement or only the matrix for producing a composite material. Thus, in particular, one among the main thread 45 and the secondary thread 38 could constitute the reinforcement and preferably be made of aramid, carbon, glass fibers, or linen, and the other among the main thread 45 and the secondary thread could constitute the matrix and preferably be made of polypropylene (PP) or polyethylene terephthalate (PET).

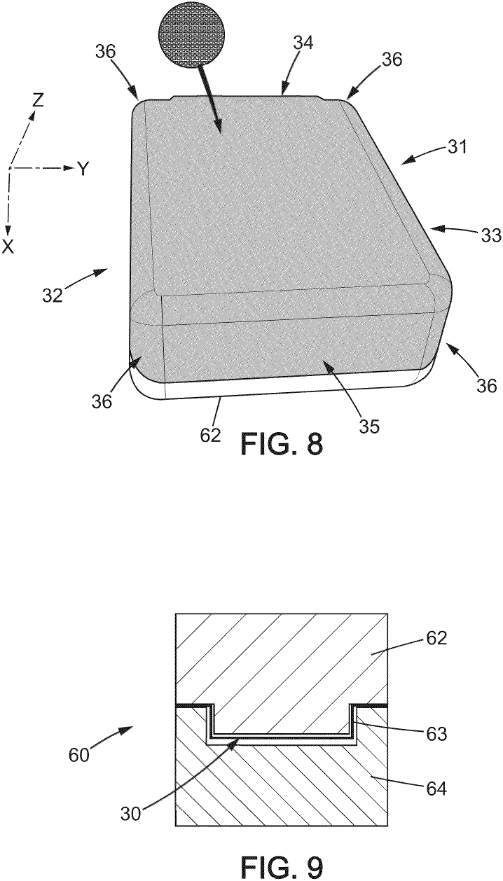

As illustrated in FIG. 8, the preform 30 is then placed on a punch 62, usually referred to as a cover.

To do this, the main zone 31 extending perpendicularly to the upright direction Z, the first longitudinal zone 32, and the second longitudinal zone 33 are bent at right angles around the longitudinal direction X in order to extend perpendicularly to the transverse direction Y, while the first transverse zone 34 and the second transverse zone 35 are bent at right angles around the transverse direction Y in order to extend perpendicularly to the longitudinal direction X. The connecting zones 36 deform to continue connecting the first longitudinal zone 32, the first transverse zone 34, the second longitudinal zone 33, and the second transverse zone 35.

In the illustrated embodiment, a single preform is shaped on the punch 62. Alternatively, several preforms 30 can be superimposed, the rows of loops of the superimposed preforms then preferably extending in different directions, in order to neutralize internal stresses and effects from twisting which could deform the shells over time.

Then, as illustrated in FIG. 9, the preform is placed in a mold 60 comprising, in addition to the punch forming a first mold element 62, a second mold element 64 (usually referred to as a die). After placing the preform in a cavity 63 between the first mold element 62 (punch) and the second mold element 64 (die), the temperature and pressure are increased in the cavity 63, preferably until reaching between 50 and 200 degrees and a pressure between 10 and 20 bar, then the temperature and pressure are preferably held constant for a few minutes to 30 minutes. The conditions of temperature, pressure, and duration are determined so that the matrix material is melted but not the reinforcement material. In particular, in the case where the main thread 45 or the secondary thread 38 are made of self-reinforced polymer, usually called SRP, the temperature is determined so that the main thread 45 or the secondary thread are only superficially melted. Indeed, the conditions of temperature, pressure, and duration must be defined so that the matrix material 48 is melted without degrading the reinforcement 46.

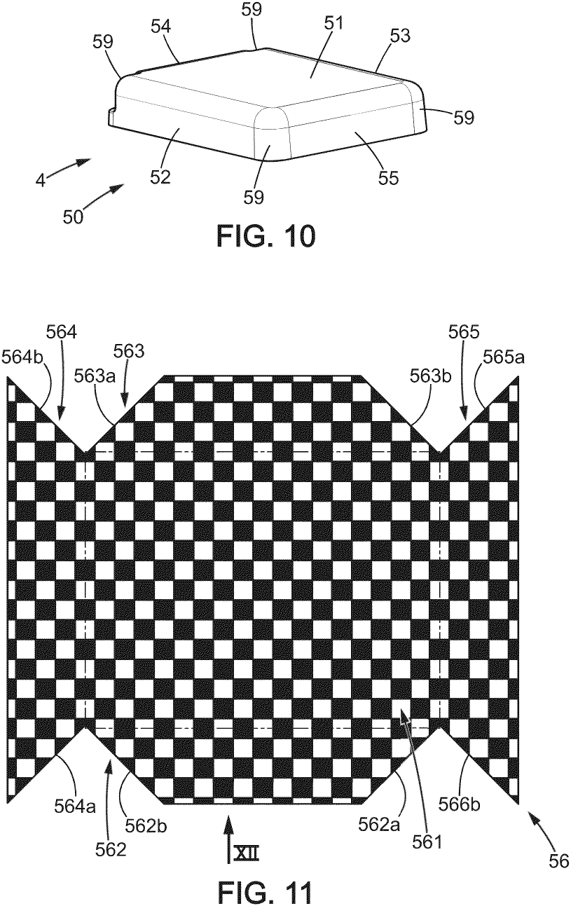

The cavity 63 is then cooled, the mold 62 is opened, and a shell 4 comprising the rigid body 50 is obtained. As illustrated in FIG. 10, the body 50 comprises a main wall 51, a first longitudinal wall 52, a second longitudinal wall 53, a first transverse wall 54, a second transverse wall 55, and corner portions 59. The main wall 50 corresponds to the main zone 31, the first longitudinal wall 52 corresponds to the first longitudinal zone 32, the second longitudinal wall 53 corresponds to the second longitudinal zone 33, the first transverse wall 54 corresponds to the first transverse zone 34, the second transverse wall 55 corresponds to the second transverse zone 35, and the corner portions 59 correspond to the connection zones 36.

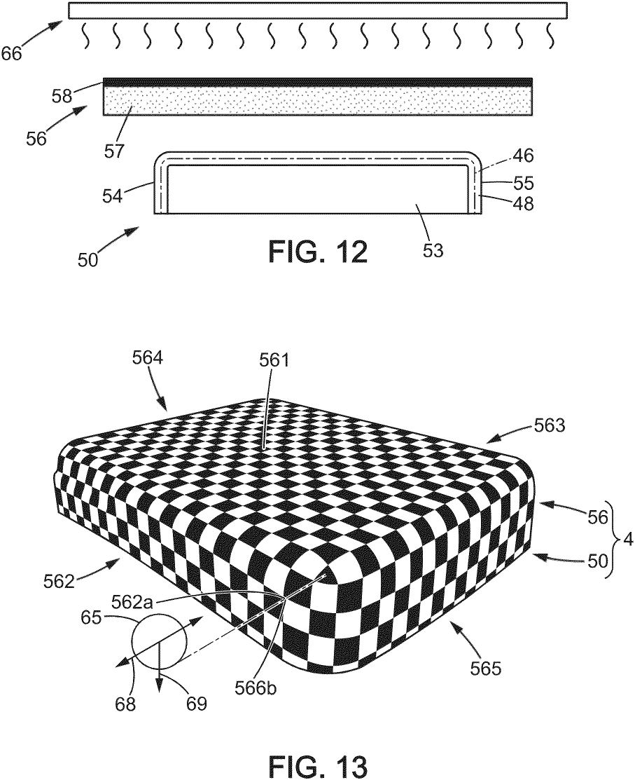

As illustrated in FIG. 12, the reinforcement 46, constituted by the core of the main thread 45 and of the secondary thread 38 in the illustrated embodiment, extends within the main wall 51, the first longitudinal wall 52, the second longitudinal wall 53, the first transverse wall 54, the second transverse wall 55, and the corner portions 59. Furthermore, the matrix 48 is formed by the material of the coating of the main thread 45 and of the secondary thread 38 which has melted in the cavity 63. The reinforcement 46 is thus embedded in the matrix 48 forming a composite complex, preferably thermoplastic.

As illustrated in FIG. 11, next a covering 56 having substantially the shape of a cross is cut to form a zone having a central zone 561 and four peripheral zones 562, 563, 564, 565. The peripheral zones each have two side edges 562a, 562b; 563a, 563b; 564a, 564b; 565a, 565b extending from the central zone 561. The central zone 561 is rectangular and the peripheral zones 562, 563, 564, 565 are trapezoidal. The covering 56 has a repeating decorative pattern extending within the central zone 561 and the peripheral zones 562, 563, 564, 565. In the illustrated embodiment, the illustrated embodiment is a checkerboard, but the black squares could be replaced by another pattern, preferably having a symmetry suitable for an aesthetic joining at the side edges 562a, 562b; 563a, 563b; 564a, 564b; 565a, 565b.

As illustrated in FIG. 12, in the embodiment shown, the covering 56 comprises a foam layer 57 and a film 58 (non-lacunar). The foam layer 57 and the film 58 are made of polyolefin, preferably polypropylene. The decorative pattern is present on the outer surface of the film 58.

As illustrated in FIG. 12, the covering 56 is heated by a heating device 66 to a temperature preferably between 140 and 200 degrees.

As illustrated in FIG. 13, the peripheral zones 562, 563, 564, 565 are folded perpendicularly to the central zone 561. The central zone 561 and the peripheral zones 562, 563, 564, 565 are pressed, preferably at between 10 bar and 20 bar for a period of preferably between 1 minute and 30 minutes, respectively against the main wall 51, the first longitudinal wall 52, the second longitudinal wall 53, the first transverse wall 54, and the second transverse wall 55. The peripheral zones 562, 563, 564, 565 also cover the corner portions 59 of the body 50.

Each side edge 562a, 562b; 563a, 563b; 564a, 564b; 565a, 565b is brought into contact with a side edge which is adjacent and the side edges which are adjacent are pressed against each other by means of a roller 65.

In particular, arrow 68 illustrates the movement of the roller 65 over the joining line between side edge 562a and side edge 566b, and arrow 69 illustrates the pressure exerted. The covering 56 adheres to the body 50 to form the second shell 4 comprising the body 50 covered with the covering 56.

Cutting the covering 56 appropriately for the repeating decorative pattern makes it possible to form a decorative pattern on the second shell 4 in which the joining line between side edge 562a and side edge 566b is invisible.

Of course, the invention is in no way limited to the non-limiting embodiment(s) described for illustrative purposes. Thus, instead of being knitted, the preform could be formed from a perforated and deformable structural element forming a reinforcement. The reinforcement could be overmolded by a material forming a matrix and preferably made of a thermoplastic polymer. Openings in the structural element forming the reinforcement could be produced by laser cutting or punching, in order to form loops extending in two directions of the type illustrated in document EP0806190A1.

Instead of being positioned on the large side face 3a, the hinge device could be placed on one of the two small side faces 3c, 3d.

The hinge device could be different and in particular could have a single hinge axis.

The first shell 2 could extend only along the lower main face 3e and form a door, the first shell 2 then not comprising any wheels.

1. A method for producing a shell for luggage, comprising:
a) producing a preform comprising a structure, the preform including a reinforcement, the structure comprising a main zone, two longitudinal zones, and two transverse zones, the structure having loops successively forming rows of loops, the rows of loops being connected to each other, the structure being produced by knitting by forming:
a first row of loops with a main thread
a second row of loops while passing the main thread through the loops of the first row of loops,
and so on in a series of rows of loops, passing the main thread of a row of loops through the loops of the previous row of loops,
b) placing the preform on a punch, and
c) impregnating the reinforcement of the preform with a matrix material in order to produce a shell comprising a body, the body being made of a composite material and comprising the matrix and the reinforcement, and the body having a main wall, two longitudinal walls and two transverse walls.

2-7. (canceled)

8. The method according to claim 1, wherein, during step a), the shape of the loops is varied in order to form at least one predetermined density zone and one high density zone.

9. The method according preceding claim 8, wherein, during step a), the structure is produced such that:
in the predetermined density zone, the loops successively follow one after another with a first loop pitch and the rows of loops follow one after another with a first row pitch,
in the high density zone, the loops successively follow one after another with a second loop pitch and the rows of loops follow one after another with a second row pitch, and
the first row pitch is at least 50% higher than, preferably double, the second row pitch.

10. The method according toclaim 9, wherein the difference between the second loop pitch and the first loop pitch is less than 20% of the first loop pitch, preferably less than 10% of the first loop pitch.

11-17. (canceled)

18. The method according to claim 1, wherein the main thread is produced from portions which alternate in coming from a first thread element and from a second thread element, the first thread element and the second thread element having different colors.

19. The method according preceding claim 1, wherein the first thread element and the second element follow one after another in succession to produce a repeating pattern in the structure.

20-21. (canceled)

22. The method according to claim 1, wherein:
during step c) a matrix material of polyolefin is used, and
during a step d) a covering of polyolefin is applied to the body.

23. The method according to claim 22, wherein, in step d), the covering and/or the body is heated and the covering is pressed against the body.

24. The method according to claim 23, wherein, during step d):
at least one among the covering and/or the body is heated to between 140 and 200 degrees, and
the covering is pressed against the body at a pressure of between 10 bar and 20 bar for a period of between 1 minute and 30 minutes.

25. The method according to claim 22, wherein:
the covering comprises a foam layer and a film, and
during step d) the foam layer is applied against the body.

26. The method according preceding claim 25, wherein the foam layer has a density of between 250 g/m² and 750 g/m², preferably between 450 g/m² and 500 g/m².

27. The method according to claim 22, wherein, in a step d′) prior to step d):
the covering is cut in the shape of a cross having a central zone and four peripheral zones, the peripheral zones each having two side edges, extending from the central zone, and
the peripheral zones are folded perpendicularly to the central zone, and each side edge is brought into contact with a side edge which is adjacent.

28. The method according to claim 27, wherein the peripheral zones are trapezoidal.

29. The method according to claim 27, wherein, in step d′) said side edges which are adjacent are heated and pressed together to weld them.

30. The method according to claim 29, wherein, during step d′) a roller is rolled over said edges which are adjacent.

31. The method according to claim 22, wherein, during step d), the covering applied to the body is of a material that for the most part (more than 50%), is the same as that of the matrix material, preferably polypropylene.

32. A shell for luggage comprising a body, said body being rigid, of composite material and comprising a matrix and a reinforcement, the body having a main wall, two longitudinal walls, and two transverse walls, said shell being characterized in that:
the reinforcement comprises at least one main zone comprising loops successively forming rows of loops, the rows of loops being connected to each other,
the reinforcement comprises a main thread and said main thread is knitted and
the reinforcement is embedded in the matrix.

33-37. (canceled)

38. The shell-according to claim 32, wherein the matrix is made of polyolefin and the body, composite, is covered with a covering made of polyolefin, preferably of polypropylene.

39. The shell-according preceding claim 38, wherein the covering comprises a foam layer and a film, the foam layer being interposed between the body and the film.

40. (canceled)

41. The shell-according to claim 32, wherein the reinforcement is made of aramid, carbon, glass fibers, or linen.

42. The shell-according to claim 32, wherein:
the body has a predetermined density zone as reinforcement and a high density zone as reinforcement,
the proportion of reinforcing material is at least 50% higher in the high density zone than in the predetermined density zone, and
the shell comprises at least one wheel attached to the body in the high density zone.

43. The shell-according to claim 32, wherein the covering has a visible outer surface and said outer surface has a repeating pattern extending over the two longitudinal walls and the two transverse walls.

44. A luggage comprising a first shell and a second shell according to claim 32, the second shell being movable relative to the first shell between an open position and a closed position, the luggage having an interior volume which is closed in the closed position and providing an access opening in the open position.
